(19) United States
(12) Patent Application Publication
(10) Pub. No.: US 2006/0184423 A1
(43) Pub. Date: Aug. 17, 2006

(54) Selecting Business Partners to Conduct Business-to-business (B2B) Transactions

(75) Inventor: Karthick Krishnamoorthy, Chennai (IN)

Correspondence Address: LAW FIRM OF NAREN THAPPETA, C/O LANDON IP, INC., 1700 DIAGONAL ROAD, SUITE 450, ALEXANDRIA, VA, 22314, US

(73) Assignee: ORACLE INTERNATIONAL CORPORATION, Redwood Shores (US)

(21) Appl. No.: 10/906,254

(22) Filed: Feb. 11, 2005

(51) Int. Cl. G06Q 99/00; G07G 1/12; G07G 5/00

(52) U.S. Cl. 705/24; 705/1

(57) ABSTRACT

A directory server which provides a reply indicating suitable supplier transaction systems (or suppliers) from which products/services of interest can be purchased by a B2B transaction. The directory server may generate such a reply in response to receiving an enquiry electronically from a buyer transaction system. The buyer transaction system conducts a B2b transaction with the indicated suitable supplier transaction system to purchase the desired service/product.

### BACKGROUND OF THE INVENTION

1. Field of the Invention

The present invention relates to electronic commerce, and more specifically to a method and apparatus for selecting business partners to conduct business-to-business (B2B) transactions.

2. Related Art

Business-to-business (B2B) transactions are often conducted using electronic media to provide efficiencies in business/industrial processes. In an example B2B transaction, a first (buyer) transaction system of a first business partner electronically communicates with a second (supplier) transaction system of a second business partner to complete a purchase transaction for a desired service/product.

In general, it is desirable that a (buyer) transaction system be provided the ability to select a business partner (and corresponding transaction system) which meets various criteria (e.g., cost, delivery time), such that the efficiencies in business processes can be enhanced.

### BRIEF DESCRIPTION OF THE DRAWINGS

The present invention will be described with reference to the accompanying drawings briefly described below.

Figure (FIG.) 1 is a block diagram of an example environment in which various aspects of the present invention can be implemented.

FIG. 2 is a flowchart illustrating the manner in which a buyer transaction system conducts a B2B transaction in an embodiment of the present invention.

FIG. 3 is a flowchart illustrating the operation of a directory server in an embodiment of the present invention.

FIG. 4 contains a table illustrating the expected transaction attributes maintained by a directory server in an embodiment of the present invention.

FIG. 5 is a block diagram illustrating an example embodiment in which various aspects of the present invention are operative when software instructions are executed.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

1. Overview

A directory server provided according to an aspect of the present invention receives an electronic enquiry from a buyer transaction system indicating a product/service of interest, and sends a reply indicating supplier transaction systems from which the product/service of interest can be purchased. The buyer transaction system can then interface with the supplier transaction system to initiate a B2B transaction to purchase the product/service of interest.

By designing the directory server to indicate appropriate business partners for various partners/services, transaction systems can be caused to select business partners meeting various criteria.

According to another aspect of the present invention, the enquiry may further specify the desired transaction attributes (cost, time to deliver, etc.) that are to be met by the business partners (or corresponding supplier transaction system), and the directory server may be designed to indicate the supplier transaction systems meeting such criteria. Alternatively, the directory server may send expected transaction attributes for each indicated supplier transaction system, and the buyer transaction system sending the enquiry may determine a suitable supplier transaction system based on the expected transaction attributes.

According to one more aspect of the present invention, the directory server can be configured to indicate access attributes (e.g., the URL/IP address, the B2B protocol used by the transaction system of each indicated partner) for each supplier transaction system. The buyer transaction system can accordingly use the access attributes to initiate the desired B2B transaction.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

2. Example Environment

FIG. 1 is a block diagram illustrating an example environment in which various aspects of the present invention can be implemented. The environment is shown containing network 120, buyer transaction system 130, directory server 150, and supplier transaction systems 170A and 170B.

Network 120 provides the connectivity between the remaining systems using protocols such as Internet Protocol (IP). Supplier transaction systems 170A and 170B represent example transaction systems using which products/services can be purchased using B2B transactions. The supplier transaction systems are used interchangeably with the corresponding suppliers in several instances in the present application.

B2B transactions can be conducted with each supplier transaction system using corresponding access attributes (i.e., the information/data that is needed to access the supplier transaction system for the purpose of conducting a B2B transaction). Examples of access attributes include B2B protocol (e.g., EDIFACT, X12), authentication information, IP address, custom details which are specific to the vendor, etc.

Buyer transaction system 130 purchases a desired service/product from a supplier transaction system using a B2B transaction. Directory server 150 enables buyer transaction system 130 to determine a suitable supplier transaction system according to various aspects of the present invention. The manner in which a buyer transaction system may interact with directory server 150 is described first, followed by the operation of directory server 150 to facilitate such a feature.

3. B2B Transaction from a Buyer Transaction System

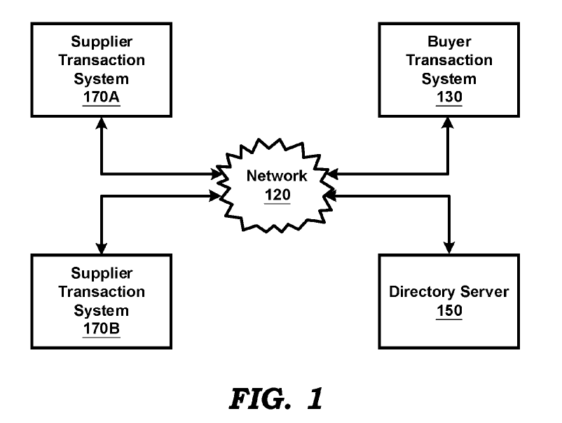

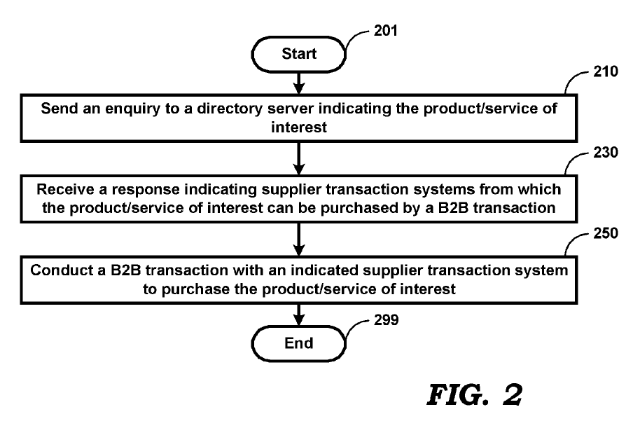

FIG. 2 is a flowchart illustrating the manner in which a buyer transaction system may purchase a product/service according to an aspect of the present invention. The flowchart is described with respect to FIG. 1 merely for illustration. However, the approach(es) can be implemented in other environments as well. The flowchart begins in step 201, in which control passes to step 210.

In step 210, buyer transaction system 130 sends an enquiry to directory server 150 indicating a product/service of interest (sought to be purchased by a B2 transaction). The product/service of interest may be determined, for example, based on the number of available units and/or expected demand. The enquiry may be sent according to any pre-specified protocol consistent with the implementation of directory server. In one embodiment, Simple Object Access Protocol (SOAP) is used to send the enquiry.

In step 230, buyer transaction system 130 receives a response from directory server 150 indicating supplier transaction systems from which the product/service of interest can be purchased by a B2B transaction. The response may also be received according to any pre-specified protocol, and SOAP may be used, as with the case of the enquiry. SOAP is described in further detail in a book entitled, “Simple Object Access Protocol (SOAP) for Web Applications”, By: Faulkner Information Services; ISBN: B00005 MBA6. For illustration, it is assumed that the response indicates that supplier transaction system 170A is suitable for the purchase.

In step 250, buyer transaction system 130 conducts a B2B transaction with an indicated supplier transaction system to purchase the product/service of interest. The B2B transaction may also be conducted using a known approach. The flow-chart ends in step 299.

Due to the use of directory server 150 as above, buyer transaction systems may be made to dynamically select suitable supplier transaction systems, thereby enhancing efficiencies in the business/industrial processes.

However, it should be understood that various extensions to the above approach are generally desirable. For example, only some of the suppliers may meet various transaction criteria (delivery time, cost, etc.), and it is desirable that a buyer transaction system be able to determine the corresponding supplier transaction systems. The manner in which such a feature can be provided is described below with respect to the operation of directory server 150 in an embodiment.

4. Operation of Directory Server

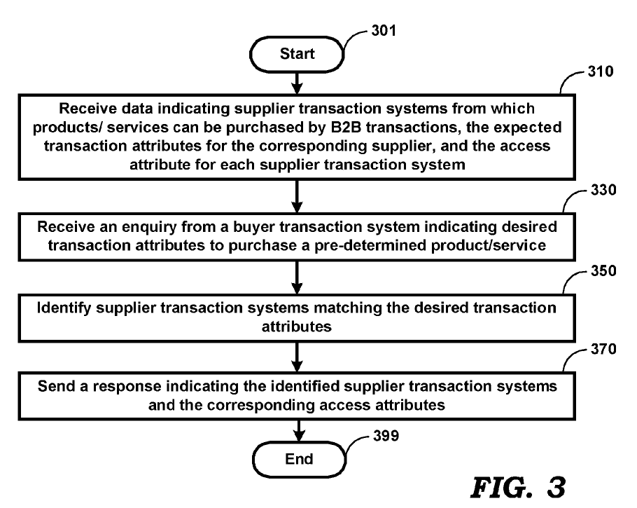

FIG. 3 is a flowchart illustrating the manner in which a directory server may operate to enable buyer transaction systems to select suitable supplier transaction systems according to an aspect of the present invention. The flowchart is described with respect to FIG. 1 merely for illustration. However, the approach(es) can be implemented in other environments as well. The flowchart begins in step 301, in which control passes to step 310.

In step 310, directory server 150 receives data indicating supplier transaction systems from which products/services can be purchased by B2B transactions, the expected transaction attributes for the corresponding supplier, and the access attribute for each supplier transaction system. The data may be received from a non-volatile memory within directory server 150 or from an external device. In general, the data needs to be updated to indicate the present desirability of purchases from corresponding suppliers.

In step 330, directory server 150 receives an enquiry from buyer transaction system 130 indicating desired transaction attributes to purchase a pre-determined product/service. The transaction attributes indicate various properties associated with the transaction such as cost, time to pay, delivery time, acceptable modes (check, cash, etc.) of payment, delivery mode, etc. In an embodiment, directory server 150 is implemented using light-weight directory access protocol (LDAP), which receives interfaces with buyer transaction systems using Simple Object Access Protocol (SOAP).

In step 350, directory server 150 identifies supplier transaction systems matching the desired transaction attributes contained in the received enquiry. The expected transaction attributes of each supplier (or corresponding supplier transaction system) may be compared with the desired transaction attributes to determine suitable supplier transaction systems.

In step 370, directory server 150 sends a response indicating the identified supplier transaction systems and the corresponding access attributes. Access attributes specify the manner in which a supplier transaction system may be accessed to conduct a B2B transaction. For example, different supplier transaction systems may be implemented to be accessible by different B2B protocols (e.g., Edifact, X12), IP addresses, etc., and the corresponding access attributes may be provided to the buyer transaction system from which the enquiry of step 330 is received.

Buyer transaction system 130 uses the access attributes to conduct a B2B transaction and purchase the desired product/service. The flowchart ends in step 399. While the directory server is described as comparing the expected transaction attributes with the desired transaction attributes and indicating suitable supplier transaction systems, it should be understood that alternative embodiments can be implemented in which directory server 150 merely sends the expected transaction attributes to buyer transaction system 130, and buyer transaction system 130 determines suitable supplier transaction system by appropriate comparison.

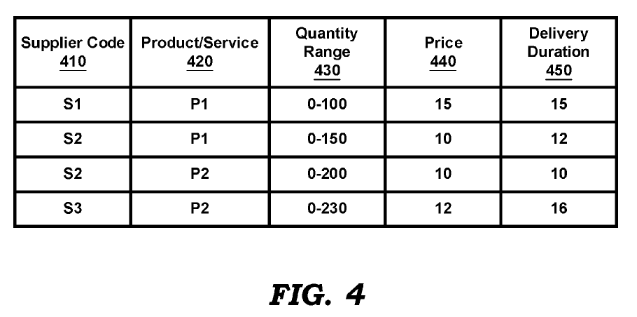

Accordingly, it may be appreciated that directory server 150 has access to expected transaction attributes associated with each supplier. The expected transaction attributes may be maintained in the form of a table, as described below with respect to FIG. 4.

5. Expected Transaction Attributes

FIG. 4 contains a table illustrating the expected transaction attributes maintained by directory server 150 in an example embodiment. As seen, the table contains columns entitled, supplier code 410, product/service code 420, quantity range 430, price 440, and delivery duration 450. Rows 461 and 462 respectively indicate that suppliers S1 and S2 can deliver product/service with code P1, and rows 463 and 464 respectively indicate that suppliers S2 and S3 can deliver product/service with code P2.

Thus, assuming that an enquiry is received with transaction attributes of product code P1, minimal price with delivery duration of less than 14 days, directory server 150 determines that only row 462 contains matching transaction attributes. Accordingly, the supplier transaction system associated with a supplier of code S2 may be sent to the buyer transaction system (sending the enquiry). Alternatively, the information in both rows 461 and 462 may be sent to buyer transaction system 130, which then compares the transaction attributes to determine a suitable supplier transaction system.

While the above example provides a simple decision tree, it should be understood that more complex criteria can be defined in choosing suitable supplier transaction systems, as will be apparent to one skilled in the relevant arts by reading the disclosure provided herein. It should be further appreciated that the features described above can be implemented in various embodiments. The description is continued with respect to an embodiment in which various features are operative when software instructions are executed.

6. Digital Processing System

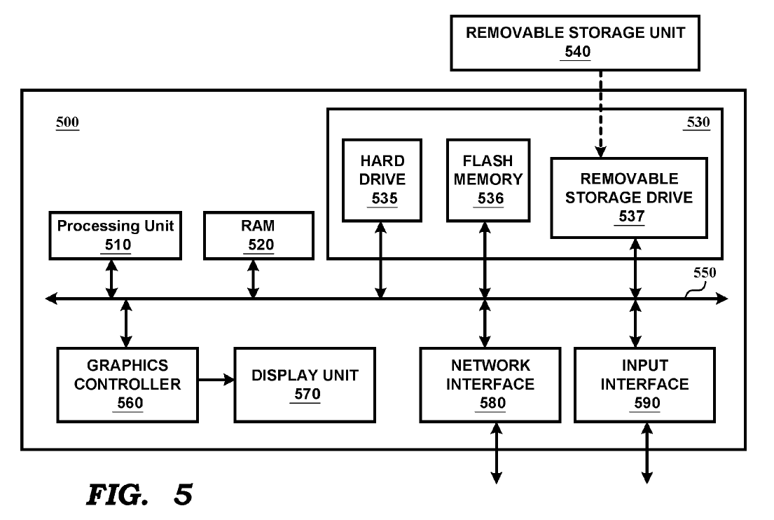

FIG. 5 is a block diagram illustrating the details of digital processing system 500 in which various aspects of the present invention are operative by execution of appropriate software instructions. System 500 may correspond to directory server 150 or buyer transaction system 130. System 500 may contain one or more processors such as central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present invention. CPU 510 may contain multiple processing units, with each processing unit potentially being designed for a specific task. Alternatively, CPU 510 may contain only a single general purpose processing unit. RAM 520 may receive instructions from secondary memory 530 using communication path 550.

Graphics controller 560 generates display signals (e.g., in RGB format) to display unit 570 based on data/instructions received from CPU 510. Display unit 570 contains a display screen to display the images defined by the display signals. Input interface 590 may correspond to a key-board and/or mouse. Network interface 580 provides connectivity to a network (e.g., using Internet Protocol), and may be used to communicate with the other systems of FIG. 1.

Secondary memory 530 may contain hard drive 535, flash memory 536 and removable storage drive 537. Secondary memory 530 may store the data and software instructions (e.g., methods instantiated by each of client system), which enable system 500 to provide several features in accordance with the present invention. Some or all of the data and instructions may be provided on removable storage unit 540, and the data and instructions may be read and provided by removable storage drive 537 to CPU 510. Floppy drive, magnetic tape drive, CD-ROM drive, DVD Drive, Flash memory, removable memory chip (PCMCIA Card, EPROM) are examples of such removable storage drive 537.

Removable storage unit 540 may be implemented using medium and storage format compatible with removable storage drive 537 such that removable storage drive 537 can read the data and instructions. Thus, removable storage unit 540 includes a computer readable storage medium having stored therein computer software and/or data.

In this document, the term “computer program product” is used to generally refer to removable storage unit 540 or hard disk installed in hard drive 535. These computer program products are means for providing software to system 500. CPU 510 may retrieve the software instructions, and execute the instructions to provide various features of the present invention described above.

7. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents. Also, the various aspects, features, components and/or embodiments of the present invention described above may be embodied singly or in any combination in a data storage system such as a database system.

What is claimed is:

1. A method of conducting B2B (business to business) transactions in a buyer transaction system, said method comprising:
sending an enquiry to a directory server indicating a product/service of interest;
receiving a response indicating a supplier transaction system from which said product/service of interest can be purchased by a B2B transaction; and
conducting said B2B transaction with said supplier transaction system to purchase said product/service of interest.

2. The method of claim 1, wherein said enquiry further contains a plurality of desired transaction attributes, wherein said response indicates that said supplier transaction system provides said product/service with matching transaction attributes.

3. The method of claim 2, wherein said desired transaction attributes contain price and quantity.

4. The method of claim 1, wherein said response indicates a plurality of expected transaction attributes with which said supplier transaction system provides said product/service of interest, wherein said buyer transaction system determines whether said supplier transaction system is suitable for conducting said B2B transaction based on said expected transaction attributes.

5. The method of claim 1, wherein said response contains a access attributes using which said supplier transaction system can be accessed to conduct said B2B transaction.

6. The method of claim 5, wherein said access attributes contain a B2B protocol using which said B2B transaction can be conducted with said supplier transaction system.

7. A method performed in a directory server to facilitate efficient B2B transactions, said method comprising:
receiving an enquiry from a buyer transaction system indicating a desired product/service; and
sending a response indicating a supplier transaction system from which said desired product/service can be purchased.

8. The method of claim 7, further comprising storing an expected transaction attributes associated with said supplier transaction system.

9. The method of claim 8, wherein said enquiry further contains a plurality of desired transaction attributes, said method further comprising comparing said desired transaction attributes with said expected transaction attributes, wherein said response indicates that said supplier transaction system provides said product/service with matching transaction attributes.

10. The method of claim 9, wherein said desired transaction attributes contain price and quantity.

11. The method of claim 7, wherein said response contains said plurality of expected transaction attributes associated with said supplier transaction system.

12. The method of claim 7, wherein said response contains a plurality of access attributes using which said supplier transaction system can be accessed to conduct said B2B transaction.

13. A computer readable medium carrying one or more sequences of instructions causing a buyer transaction system to conduct B2B (business to business) transactions, wherein execution of said one or more sequences of instructions by one or more processors contained in said buyer transaction system causes said one or more processors to perform the actions of:
sending an enquiry to a directory server indicating a product/service of interest;
receiving a response indicating a supplier transaction system from which said product/service of interest can be purchased by a B2B transaction; and
conducting said B2B transaction with said supplier transaction system to purchase said product/service of interest.

14. The computer readable medium of claim 13, wherein said enquiry further contains a plurality of desired transaction attributes, wherein said response indicates that said supplier transaction system provides said product/service with matching transaction attributes.

15. The computer readable medium of claim 13, wherein said response indicates a plurality of expected transaction attributes with which said supplier transaction system provides said product/service of interest, wherein said buyer transaction system determines whether said supplier transaction system is suitable for conducting said B2B transaction based on said expected transaction attributes.

16. The computer readable medium of claim 13, wherein said response contains an access attribute using which said supplier transaction system can be accessed to conduct said B2B transaction.

17. A computer readable medium performed in a directory server to facilitate efficient B2B transactions, said computer readable medium comprising:
receiving an enquiry from a buyer transaction system indicating a desired product/service; and
sending a response indicating a supplier transaction system from which said desired product/service can be purchased.

18. The computer readable medium of claim 17, further comprising storing an expected transaction attributes associated with said supplier transaction system.

19. The computer readable medium of claim 18, wherein said enquiry further contains a plurality of desired transaction attributes, further comprising comparing said desired transaction attributes with said expected transaction attributes, wherein said response indicates that said supplier transaction system provides said product/service with matching transaction attributes.

20. The computer readable medium of claim 17, wherein said response contains said plurality of expected transaction attributes associated with said supplier transaction system.

21. The computer readable medium of claim 17, wherein said response contains a plurality of access attributes using which said supplier transaction system can be accessed to conduct said B2B transaction.
